(19) United States
(12) Patent Application Publication
(10) Pub. No.: US 2007/0216642 A1
(43) Pub. Date: Sep. 20, 2007

(54) System For 3D Rendering Applications Using Hands

(75) Inventor: Jan Kneissler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/576,903

(22) PCT Filed: Oct. 13, 2005
(86) PCT No.: PCT/IB05/53371

§ 371 Date: Apr. 9, 2007

(30) Foreign Application Priority Data
Oct. 15, 2004 (EP) 04300680.8

(51) Int. Cl. G09G 5/00

(52) U.S. Cl. 345/156

(57) ABSTRACT

The present invention relates to a system (200) for rendering a three-dimensional object, comprising an input device (202, 302), a processor (204, 306), and a picture reproduction device (206, 308). The input device (202, 302) comprises an image sensor (303) for capturing images of a first hand of a user, and is arranged to communicate the image to the processor (204, 306). The processor (204, 306) is arranged to process the images to determine movements of at least a part of the first hand for generating a control signal. The picture reproduction device (206, 308) is arranged to display 3D data of the three-dimensional object according to the control signal. While capturing images of the first hand of the user, the input device (202, 302) is adapted to be held in a second hand of the user during operation. A method complying with the features of the system (200) is also disclosed.

### FIELD OF THE INVENTION

The present invention relates to a system and method for rendering a three-dimensional object. In particular, the present invention relates to determining a movement of at least a part of a hand and displaying 3D data of the three-dimensional object according to the determined movement.

### BACKGROUND OF THE INVENTION

Creation, analysis and viewing of virtual 3D objects in science, engineering, medicine, and architecture, as well as in computer gaming, put demand on rendering the 3D objects according to a demand of a user. In existing rendering applications, mouse, trackball, or keyboard is used for control of the shown image. Translations and rotations are typically performed by click-and-drag operations, and zooming is performed by pushing a slider bar or pressing buttons or keys. Controlling by visual gestures are presented in O'Hagan et al, “Visual gesture interfaces for virtual environments”, User Interface Conference, 2000, AUIC 2000. First Australasian, 31 Jan.-3 Feb. 2000, pages 73-80. O'Hagan et al discloses a vision-based gesture interface to virtual environments, where a user is enabled to manipulate objects within the environment. Manipulations include selection, translation, rotation, and resizing of objects, and also changing the viewpoint of a scene, e.g. zooming. The system allows the user to navigate or perform a fly-through operation of 3D data. A twin camera system is mounted above a projection table to provide stereo images of the user and specifically the user's hands. Occlusions of vital parts of images are likely, and the fact that the distance between the camera system and the user, as well as that the camera inclination are not always optimal, imply that the solution disclosed in O'Hagan et al do not give satisfactory image capturing. It is therefore a problem with the prior art that image capturing is not satisfactory.

### SUMMARY OF THE INVENTION

It is therefore a general object of the present invention to overcome the above stated problem, and a particular object of the present invention is to provide an input system and method using hands, for a rendering application, with improved image capturing.

The above objects are achieved according to a first aspect of the present invention by a system for rendering a three-dimensional object, comprising an input device, a processor, and a picture reproduction device, wherein the input device comprises an image sensor for capturing images of a first hand of a user, and is arranged to communicate said images to the processor; the processor is arranged to process said images to determine movements of at least a part of said first hand for generating a control signal; and the picture reproduction device is arranged to display 3D data of said three-dimensional object according to said control signal, wherein said input device is arranged to be held in a second hand of the user during operation.

An advantage of this is that a user of the system is enabled to intuitively adjust distance between the input device and the hand of which images are to be captured, avoid occlusions, and achieve a more ergonomic work situation.

Display of 3D data of the three-dimensional object may comprise showing an image of said three-dimensional object.

The control signal may also be dependent on a determined distance between the input device and said first hand. The control signal may also be dependent on a determined orientation of the input device. The control signal may also be dependant on a determined gesture of said first hand. Magnification, brightness, contrast, hue, perspective, or view, or any combination thereof, of said image may be controlled by said control signal.

Advantages of these features are provision of advanced control of the 3D data, e.g. an image, presented by the rendering system.

Communication between said input device and said processor may be wireless.

The above objects are achieved according to a second aspect of the present invention by a method of rendering a three-dimensional object, comprising the steps of: capturing a plurality of images of a first hand by operating an image capturing input device by a second hand; processing said images to determine movements of at least a part of said first hand; and displaying 3D data of said three-dimensional object, wherein a view of said picture is dependent on said determined movements.

The method may further comprise the step of determining a distance between the input device and said first hand, wherein said view is dependent on said distance. The method may further comprise the step of determining an orientation of the input device, wherein said view is dependent on said orientation.

The method may further comprise the step of determining a gesture of said first hand, wherein said view is dependent on said gesture.

The method may further comprise the step of controlling magnification, brightness, contrast, hue, or perspective, or any combination thereof, of said view dependant on a determined distance, orientation, or gesture, or any combination thereof.

The advantages of the features of the second aspect of the invention are essentially equal to those of the first aspect of the invention.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a system in operation according to prior art;

FIG. 2 is a block diagram of a system according to the present invention;

FIG. 3 shows the system according to the present invention in operation; and

FIG. 4 is a flow chart of a method according to the present invention.

### DETAILED DESCRIPTION OF THE INVENTION

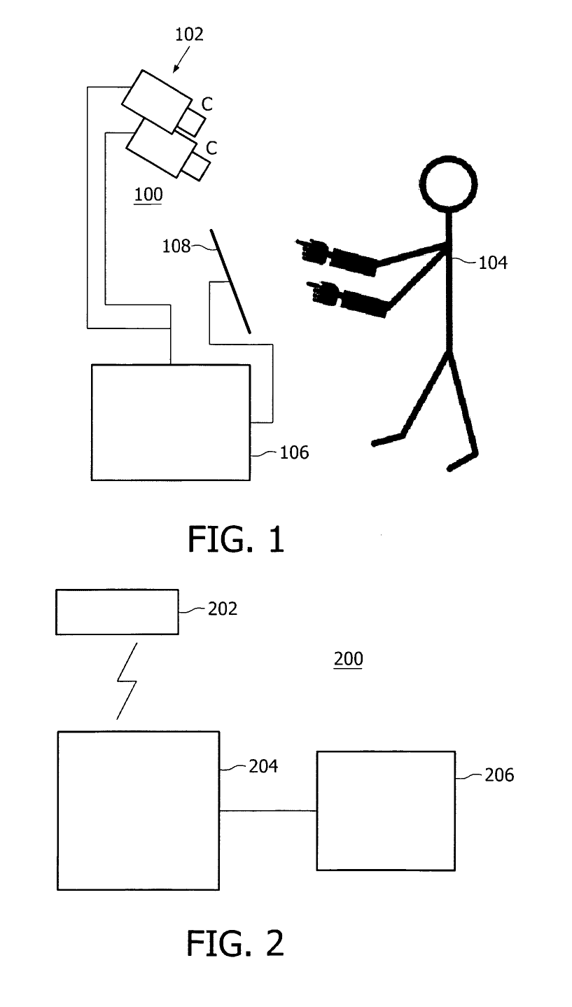

FIG. 1 shows a system 100 in operation according to prior art, wherein a twin camera arrangement 102 is adapted to capture a picture of a user 104, or particularly the hand or hands of a user. The camera arrangement 102 is coupled to a computer 106, which is arranged to determine gestures from images captured by the camera arrangement 102. The determined gestures are used to control a picture shown on a screen 108.

FIG. 2 is a block diagram of a system 200 according to the present invention. The system comprises a hand-held input device 202 comprising an image capturing means, e.g. a camera (not shown) and a communication means (not shown) for wirelessly communicating with a processor 204. The communication means preferably utilizes some short range communication technology, such as Bluetooth, WLAN (Wireless Local Area Network), or IrDA (Infrared Data Association). The communication can also be a wired communication, or an arbitrary radio communication.

The input device captures images of a user's hand and transmits the images or parametrized data of the images to the processor.

The processor 204 receives the captured images or data on the captured images and processes them to determine movements of the user's hand, or parts of the user's hand. Thereby, hand movements and gestures can be determined by the processor 204. Further, orientation of the input device can be determined, e.g. by a gyroscope, to provide information from which direction the images are taken. This information can be used to enhance control of image rendering, as will be described below. Distance between the input device and the hand of which the images are captured, i.e. the distance between the user's hands, can be determined, e.g. by image processing or direct measurement, to provide further control of image rendering. For example, this is an intuitive way to control magnification or zooming, or combined with a gesture, to control a plurality of parameters, such as magnification, brightness, contrast, hue, or perspective.

The processor 204 generates a picture of a 3D object to be shown based on the determined inputs and their impact on rendering parameters, such as rotation and translation, and other picture parameters, such as brightness and hue. The picture is then shown on a picture reproduction device 206, e.g. a screen or a head mounted display.

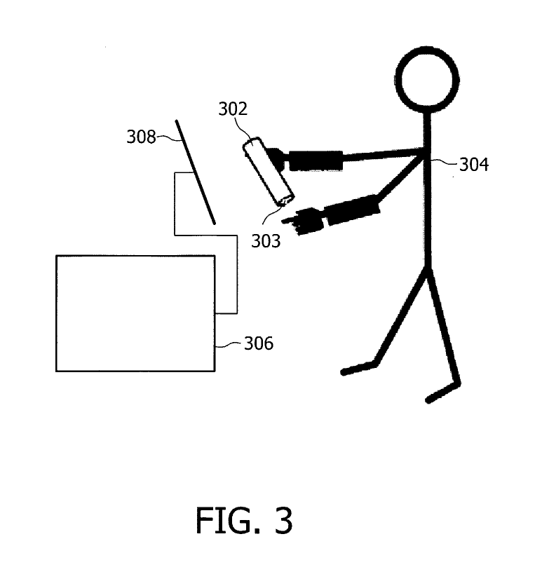

FIG. 3 shows the system according to the present invention in operation. A hand-held input device 302 with an image capturing means 303 is enabled to capture images of a first hand of a user 304 by being held in a second hand of the user 304. The input device 302 is in communication with a processor 306 by any communication technology, as described above with reference to FIG. 2. The processor 306 generates 3D data, comprising an image of a 3D object, in dependence on movements of the user's second hand, or parts of the first hand of the user 304, as is described in detail above with reference to FIG. 2. The 3D data is displayed on a picture reproduction device 308, e.g. a screen. Thus, the user is enabled to intuitively and ergonomically control the rendering of the 3D object.

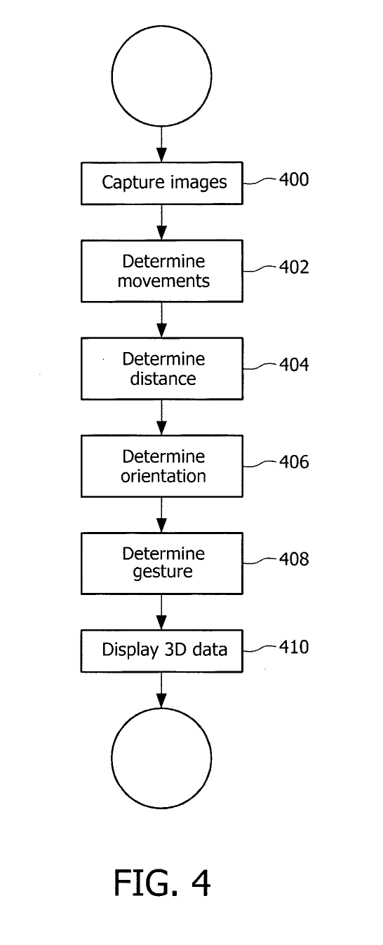

FIG. 4 is a flow chart of a method according to the present invention. Images of the user's hand are captured in an image capturing step 400. The images are then processed such that movements of a user's hand can be determined in a movement determination step 402, distance between the input device and the hand to be imaged can be determined in a distance determination step 404, orientation of the input device can be determined in an orientation determination step 406, and gestures can be determined in a gesture determination step 408. 3D data is then displayed according to the determined input parameters according to predetermined rules and schemes in a 3D data displaying step 410. It should be noted that the nature of the technology, and thus also the method, is that real-time constraints are rather strict to provide a feasible rendering. Thus is the sequential description of the method more or less only for descriptive purposes. In practice, the steps are performed in any order, in different orders from time to time, and sometimes performed in parallel, with the only demand that there is required data available for the step to work with. Further, the method is running as long as the operation of the rendering system is running.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for rendering a three-dimensional object, comprising an input device (202, 302), a processor (204, 306), and a picture reproduction device (206, 308), wherein the input device (202, 302) comprises an image sensor (303) for capturing images of a first hand of a user, and is arranged to communicate said image to the processor (204, 306);
the processor (204, 306) is arranged to process said images to determine movements of at least a part of said first hand for generating a control signal; and
the picture reproduction device (206, 308) is arranged to display 3D data of said three-dimensional object according to said control signal,
wherein said input device (202, 302) is adapted to be held in a second hand of the user during operation.

2. The system according to claim 1, wherein said control signal also is dependent on a determined distance between the input device (202, 302) and said first hand.

3. The system according to claim 1, wherein said control signal also is dependent on a determined orientation of the input device (202, 302).

4. The system according to claim 1, wherein said control signal also is dependant on a determined gesture of said first hand.

5. The system according to claim 1, wherein magnification, brightness, contrast, hue, perspective, or view, or any combination thereof, of said 3D data is controlled by said control signal.

6. The system according to claim 1, wherein communication between said input device (202, 302) and said processor (204, 306) is wireless.

7. A method of rendering a three-dimensional object, comprising the steps of:
capturing a plurality of images of a first hand by operating an image capturing input device (202, 302) by a second hand;
processing said images to determine movements of at least a part of said first hand; and
displaying 3D data of said three-dimensional object, wherein a view of said 3D data is dependent on said determined movements.

8. The method according to claim 7, further comprising the step of determining a distance between the input device (202, 302) and said first hand, wherein said view is dependent on said distance.

9. The method according to claims 7, further comprising the step of determining an orientation of the input device (202, 302), wherein said view is dependent on said orientation.

10. The method according to claim 7, further comprising the step of determining a gesture of said first hand, wherein said view is dependent on said gesture.

11. The method according to claim 7, further comprising the step of controlling magnification, brightness, contrast, hue, perspective, or any combination thereof, of said view dependant on a determined distance, orientation, or gesture, or any combination thereof.
